(19) United States
(12) Patent Application Publication
(10) Pub. No.: US 2024/0125228 A1
(43) Pub. Date: Apr. 18, 2024

(54) PERCUSSION DRILLING APPARATUS AND METHOD (WITH DAMPER)

(71) Applicant: Rig Technologies International Pty Ltd, Welshpoo! Western Australia (AU)

(72) Inventors: Kamil ROGOZINSKI, Welshpool Western Australia (AU); Nick BUTERS, Welshpool Western Australia (AU); Jonathan LOWE, Welshpool Western Australia (AU); Paul KALISCH, Welshpool Western Australia (AU); Ralf ZAEPER, Welshpool Western Australia (AU); Kai-Uwe OTT, Welshpool Western Australia (AU); Matt SCHUBERT, Welshpool Western Australia (AU); Timothy HOPPER, Welshpool Western Australia (AU)

(73) Assignee: Rig Technologies International Pty Ltd, Welshpool Western Australia (AU)

(21) Appl. No.: 18/278,423

(22) PCT Filed: Feb. 23, 2022
(86) PCT No.: PCT/AU2022/050144

§ 371 Date: Aug. 23, 2023

(30) Foreign Application Priority Data
Feb. 23, 2021 (AU) 2021900484

(51) Int. Cl. E21B 47/017; E21B 1/30; F16F 15/12

(52) U.S. Cl. CPC E21B 47/017; E21B 1/30; F16F 15/1201; F16F 2236/12

(57) ABSTRACT

A damper apparatus for use in pneumatic percussion drilling comprises a body having one or more damper apparatus supporting a measuring instrument. Each damper apparatus dampens shock/vibration from the pneumatic percussion drilling that is experienced by the measuring instrument.

### FIELD OF THE INVENTION

The present invention relates to an apparatus and methods used during percussion drilling operations.

### BACKGROUND

The following discussion of the background art is intended to facilitate an understanding of the present invention only. It should be appreciated that the discussion is not an acknowledgement or admission that any of the material referred to was part of the common general knowledge as at the priority date of the application.

Percussion drilling, such as reverse circulation drilling, uses a bit which is repeatedly hammered fracture rock and to progressively drill or bore through the earth. Percussion drilling creates a harsh environment which is not conducive to measuring tools and components which are sensitive to rapid changes in motion and/or repeated impacts with the associated shock/vibration that have been measured to be in excess of 3500 g force in the x axis (longitudinal with the drill string) and in excess of 1000 g force in the y axis and in excess of 5000 g in the z axis at 1.7 m from the bit (right behind the hammer).

Traditional methods of percussion drilling operations are conducted in at least two stages which include a drilling stage and a logging stage. During the drilling stage a drill string is mechanically operated by drilling machinery. Following which, the second stage requires separately lowering additional equipment to log information about the hole that has been drilled including depth, density and gamma radiation of the drilling formation.

Devices that can reduce and/or eliminate the need or timing of the second stage are commonly sought. It is against this background that the present invention is presented.

Throughout the specification unless the context requires otherwise, the word “comprise” or variations such as “comprises” or “comprising”, will be understood to imply the inclusion of a stated integer or group of integers but not the exclusion of any other integer or group of integers.

Throughout the specification unless the context requires otherwise, the word “include” or variations such as “includes” or “including”, will be understood to imply the inclusion of a stated integer or group of integers but not the exclusion of any other integer or group of integers.

### SUMMARY OF INVENTION

According to a first aspect there is provided a damper apparatus for use in pneumatic percussion drilling comprising:
a body having one or more damper apparatus supporting a measuring instrument;
wherein the or each damper apparatus dampens shock/vibration from the pneumatic percussion drilling that is experienced by the measuring instrument.

In an embodiment, the pneumatic percussion drilling is reverse circulation drilling.

In an embodiment, the shock/vibration may comprise independently, or in combination, axial, radial and/or rotational shock/vibration.

In an embodiment, the shock/vibration that is damped is at least 2000G force, possibly 3000G force or more and typically in the order of 3500G force. In an embodiment, the shock/vibration experience by the measuring instrument is damped to less than 500G force, preferably less than 300G force, more preferably less than 200G force, even more preferably less than 100G force, and more preferably still in the order of 30G force. In an embodiment, the shock/vibration that is damped by at least an order of magnitude.

In an embodiment, one or more of the one or more damper apparatus comprise one or more resiliently compressible portions, preferably at least two resiliently compressible portions having different elasticity. More preferably, the one of more damper apparatus comprise at least three damper portions, each having a different elasticity. In an embodiment, a first of the elasticities is provided by a first material being in compression. In an embodiment, a second of elasticities is provided by bending or flexing of a first thickness of a second material. In an embodiment, a third of the elasticities is provided by a second thickness of the second material being in compression.

In an embodiment, the or each resiliently compressible portion comprises a silicone compressible body. In an embodiment, one or more of the one or more resiliently compressible portions comprise silicone dampers.

In an embodiment, one or more of the one or more resiliently compressible portions comprise polymer dampers, preferably formed of polyurethane. In an embodiment, one or more of the one or more resiliently compressible portions comprise a ring, preferably a polymer ring.

In an embodiment, one or more of the one or more damper apparatus comprise one or more movement limiting portion.

In an embodiment, the polymer ring comprises a polyurethane ring.

In an embodiment, the or each polyurethane ring is resiliently flexible.

In an embodiment, the or each polyurethane ring is substantially ‘U’ or ‘V’ shaped in cross section. In an embodiment, the polymer ring dampens by elastically resisting deformation urging legs of the U or V shape together until they meet and then dampens by elastically resisting deformation of the legs being compressed further together.

In an embodiment, the one or more resiliently compressible portions are housed in the movement limiting portion.

In an embodiment, the movement limiting portion comprises a shroud.

In an embodiment, the movement limiting portion resists lateral movement of the one or more resiliently compressible portions, preferably beyond an inner diameter of the movement limiting portion. In an embodiment the movement limiting portion acts to apply a shock/vibration force to the one or more resiliently compressible portions.

In an embodiment, the shroud comprises an elliptical formed wall.

In an embodiment, a support between the body and the resiliently compressible portions and/or movement limiting portions is elliptical in form.

In an embodiment, the elliptical formed wall receives the elliptical resiliently compressible portion and preferably the interaction of the elliptical wall and elliptical resiliently compressible portion limits rotation of the resiliently compressible portion.

In an embodiment, the or each polymer ring is between the support and the shroud in a radial direction.

In an embodiment, the silicone damper is between the ring and the shroud in an axial direction.

In an embodiment, a major axis of the support is longer than a minor axis of the shroud.

In an embodiment, the major axis of the support is prevented from rotating across the minor axis of the shroud.

In an embodiment, a force from the movement limiting portion increases as the major axis of the support rotates towards the minor axis of the shroud.

In an embodiment, the movement limiting portion is sized and/or shaped and/or of a mass to be non-resonant with shock/vibration from the percussion drilling.

In an embodiment, the damper apparatus is arranged to provide damping of movement prior to the movement being limited by the movement limiting portion.

In an embodiment, one of the damper apparatuses is at each longitudinal end of the measuring instrument.

In an embodiment, the measuring instruments are arranged to measure relative movement and orientation. In an embodiment, the measuring instruments comprise one or more of an accelerometer and/or gyroscope.

According to a second aspect there is provided a method of measuring while percussion drilling, comprising supporting a measuring instrument within a body of a drill string and damping shock/vibration from pneumatic percussion drilling with the drill string so as to dampen the shock/vibration as experienced by the measuring instrument.

According to a third aspect there is provided a damper apparatus for use in percussion drilling comprising:
a body having one or more damper apparatus supporting a measuring instrument; wherein the or each damper apparatus dampens shock/vibration from the percussion drilling that is experienced by the measuring instrument, wherein the one or more damper apparatus comprises at least two portions each comprising a different elasticity.

### BRIEF DESCRIPTION OF DRAWINGS

Preferred embodiment of the invention will now be described with reference to the following drawings, in which:

FIG. 1 is a side view of a drill rod comprising a damping apparatus according to an embodiment of the present invention;

FIG. 2 is a side view of the drill rod without the casing showing the damping apparatus according to an embodiment of the present invention;

FIG. 2A is an isometric view of the casing which may cover the damping apparatus according to an embodiment of the present invention;

FIG. 2B is an isometric view of the measuring instruments coupled to the damping apparatus within the body according to an embodiment of the present invention;

FIG. 3 is a cross-sectional view of the drill rod having the damping apparatus mounted within according to an embodiment of the present invention;

FIG. 4 is a side view of a measurement tool having a damping apparatus coupled at each end according to an embodiment of the present invention;

FIG. 4A is a side view of a gamma ray detector coupled to a damping apparatus according to an embodiment of the present invention;

FIG. 5 is a side view of the measurement tool and damping apparatus shown in FIG. 4;

FIG. 6 is an isometric view of a plate which measuring instruments may be coupled to according to an embodiment of the present invention;

FIG. 7 is an end view of the plate shown in FIG. 6 showing an elliptical shape of a support of the plate according to an embodiment of the present invention;

FIG. 8 is an isometric view of a damper apparatus according to an embodiment of the present invention;

FIG. 9 in an isometric view of a shroud of the damper apparatus of an embodiment of the present invention;

FIG. 10 is a cross sectional view of a ring of the damper apparatus according to an embodiment of the present invention;

FIG. 11 is a side view of a silicone damper of the damper apparatus according to an embodiment of the present invention;

FIG. 11A is an isometric view of an alternative custom moulded damper of the damper apparatus according to an embodiment of the present invention;

FIG. 11B is an isometric view of an alternative damper comprising o-rings according to an embodiment of the present invention;

FIG. 12A is a cross-sectional view of the damping apparatus according to an embodiment of the present invention; and

FIG. 12B is a cross-sectional view of the drill rod having inner compartments with a damper apparatus according to an embodiment of the present invention.

### DESCRIPTION OF EMBODIMENTS

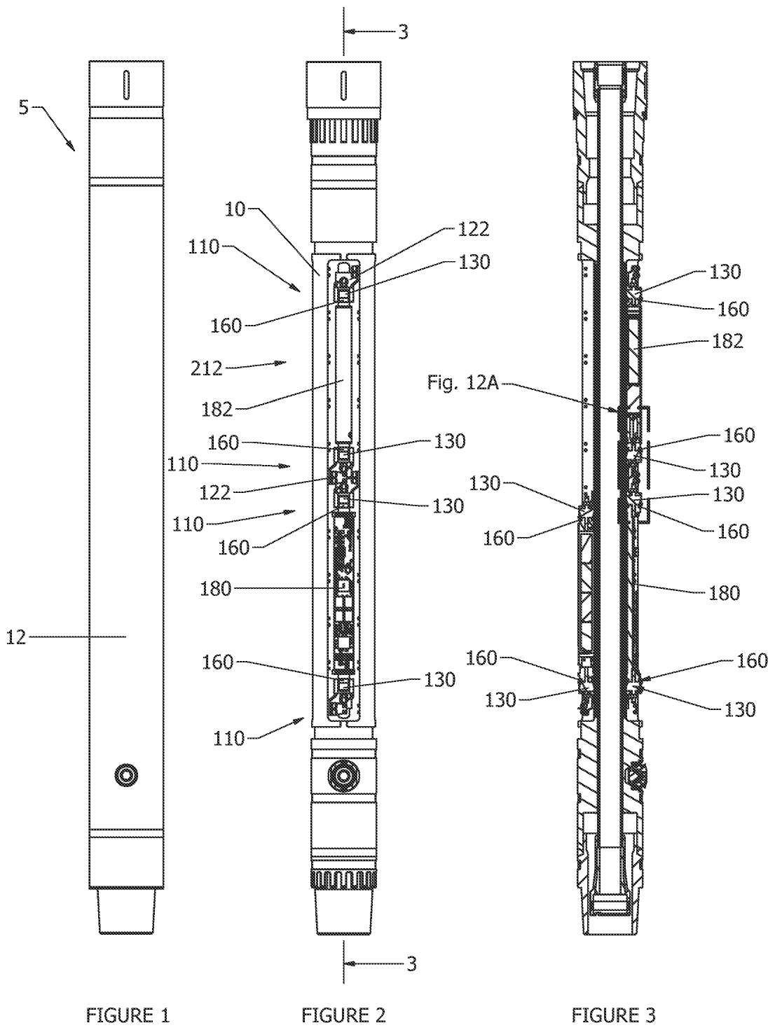

Referring to FIGS. 1, 2, 2A, 2B and 3 there is provided drill rod 5 comprising an elongate body 10 within a cylindrical casing 12 having ends suitable for connection into a percussion drilling drill string in place of a standard drill rod. Typically, this will be immediately behind the bottom hole assembly including the drill head in the drill string since the measurements are desired to be taken from a position immediately behind the drill head. Typically, the drill head comprises the drill bit and a hammer which acts on the drill bit to break rock contacted by the drill bit.

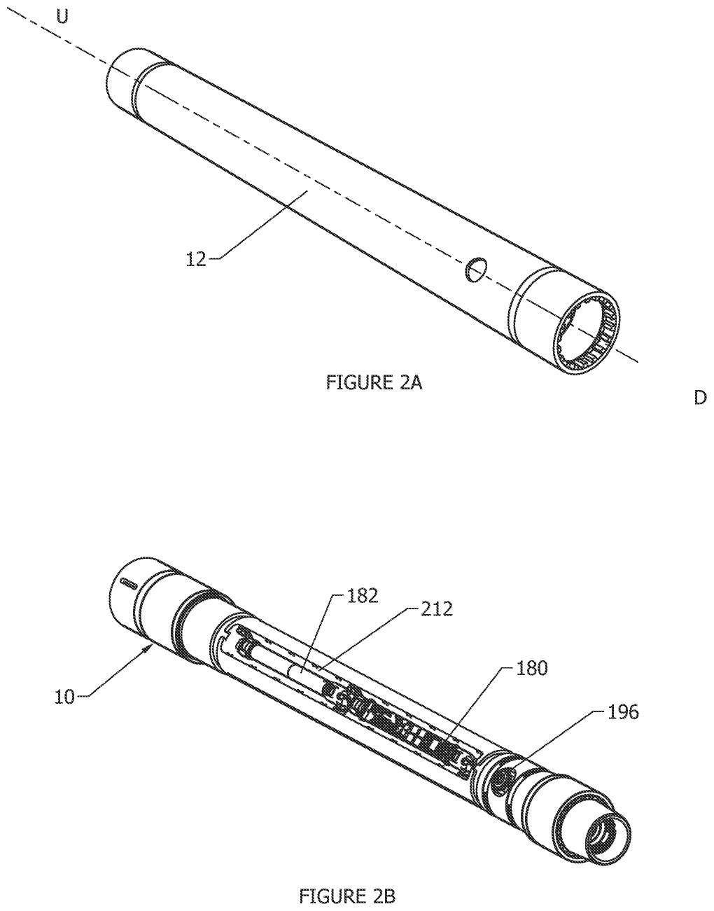

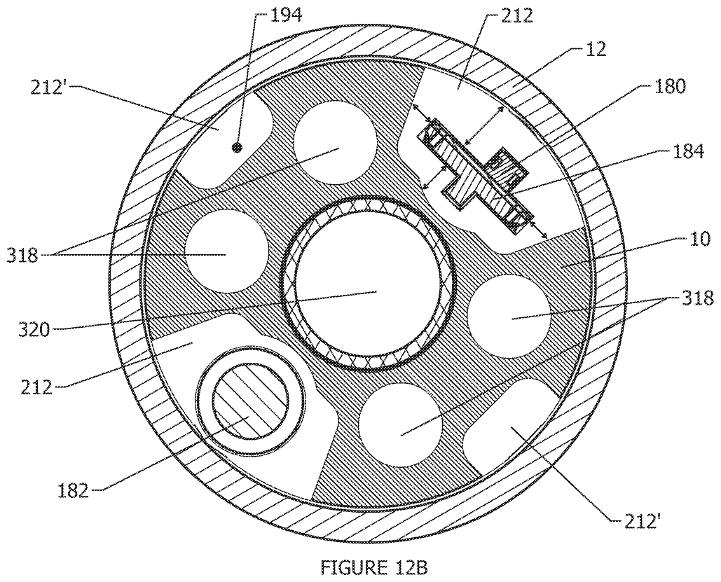

The body 10 comprises longitudinally extending compartments 212 arranged around an outer diameter of the body 10. Each compartment 212 is in the form of a recess or slot as seen in FIGS. 2B and 12B. In an embodiment there are two large compartments 212 on opposite sides of the body 10. The large compartments 212 are able to receive one or more measuring instruments 180, as described further below. In an embodiment there may be additional compartments, such as smaller compartments 212′ on opposite side of the body 10, and each between two of the larger compartments 212. Each of the compartments 212 may have one or more attachment means for securing a mount 122 to the body 10, typically at a side wall of the compartment 212. In an embodiment the attachment means is in the form of one or more screws or bolts 112 in threaded engagement with a corresponding hole in the side wall 114 (see FIG. 12A). This facilitates placement, installation and removal of the measuring instruments 180. Furthermore, the holes in the side wall 114 of the body allow for adjustment of positioning of each damping apparatus 110 thereby allowing for measuring instruments of different lengths to be placed in each of the compartments 212 at a desired position therein.

As seen in FIGS. 2, 2B and 3 the body 10 has two measuring instruments 180, 182 each coupled between two damping apparatuses 110.

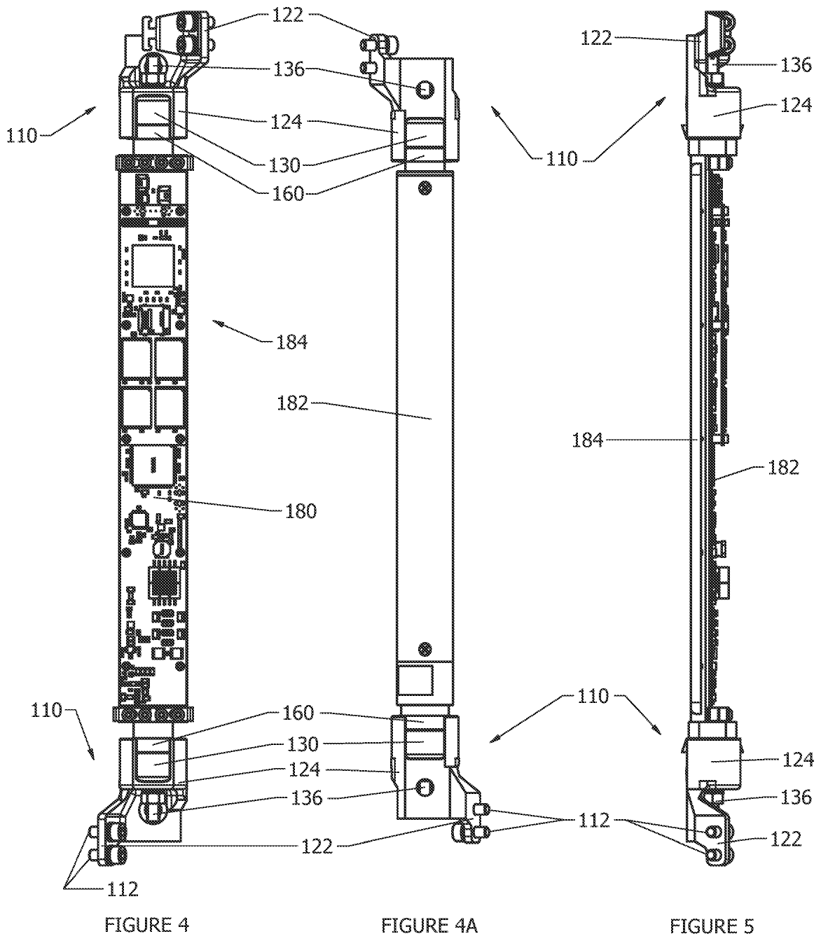

Referring to FIGS. 4, 4A, 5 and 12A, the mount 122 is connected to the measuring instruments 180 or a support 186 for the measuring instrument 180 via a damping apparatus 110. The damping apparatus 110 dampens shock/vibration experienced by the measuring instruments 180 during percussion drilling operations. In an embodiment, the damping apparatus is arranged to dampen forces exerted longitudinally with respect to the length of the body 10 and/or radially with respect to the length of the body 10 and/or rotationally about a longitudinal axis of the body 10 (or tangentially thereto) and/or in other directions. In this embodiment, the damping apparatus 110 comprises a resiliently compressible portion and a movement limiting portion. In an embodiment, the resiliently compressible portion comprises two or more sub-portions each with a different elasticity. In an embodiment, each of the portions is arranged to dampen a respective set of one or more of the different directions of force. More preferably, there are at least three damper portions, each having a different elasticity. In an embodiment, a first of the elasticities is provided by a first material being in compression. In the embodiment described below this is the silicone damper. In an embodiment, a second of elasticities is provided by bending or flexing of a first thickness of a second material. In an embodiment, a third of the elasticities is provided by a second thickness of the second material being in compression. In the embodiment described below the second material is the polymer ring.

In an embodiment, one of the sub-portions is a silicone or rubber and the other of the sub-portions is an elastomer. Preferably the silicone comprises a soft silicone gel, such as Alpha GEL made by Taica Corporation. Other suitable materials may include, but are not limited to, polymers, such as sorbothane, or one of a number of compositions of room temperature vulcanizing (RTV) silicone. Preferably the elastomer is a polymer, such as polyurethane. In an embodiment, the movement limiting portion constrains movement of one or both of the sub-portions such that a vibrational/shock force is applied to the respective sub-portions causing it/them to elastically deform.

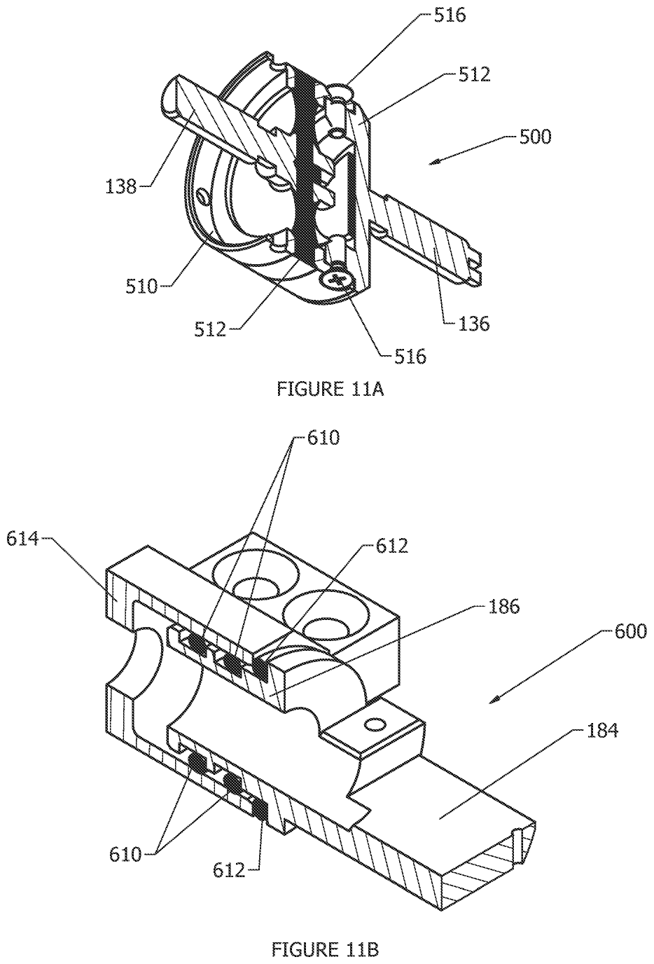

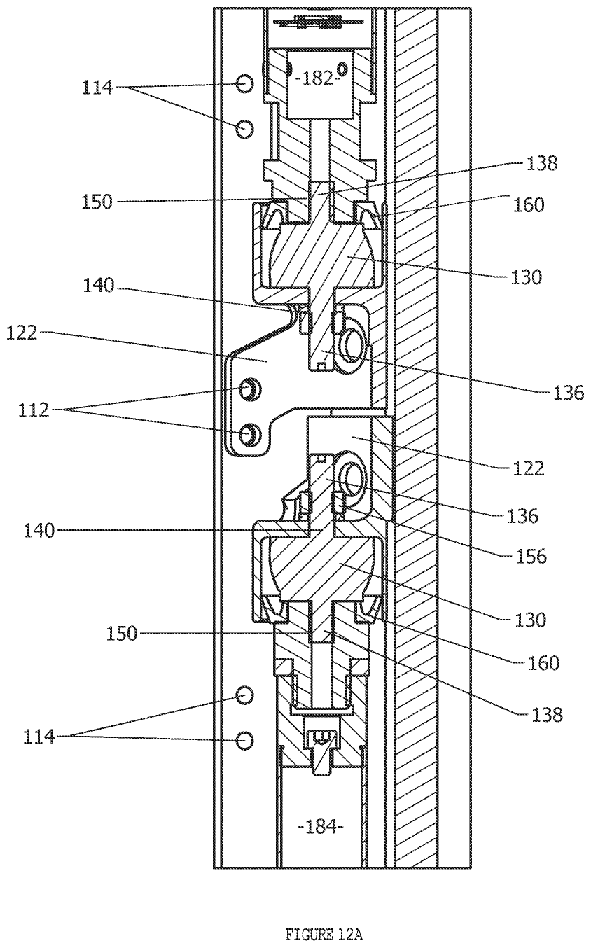

In an embodiment, the movement limiting portion is a shroud 124. In an embodiment, the silicone or rubber sub-portion is a damper, preferably a silicone damper 130 (for example, a Taica M6 Stainless Steel Shock Mount MN-3 SUS or similar as described below in relation to FIG. 11). In an embodiment, the elastomer sub-portion is a compressible/resilient ring 160. The shroud 124 receives one or more silicone damper 130 and the compressible/resilient ring 160. The shroud 124 is supported by the mount 122. Preferably the shroud 124 and mount 122 are integrally formed as a single piece. The resiliently compressible portion supports the support 186 which in turn supports the measurement instrument 180. The damping apparatus 110 is capable of coupling a measuring instrument 180, via the support 186, to the body 10, via the mount 122, to dampen the shock/vibration that the measuring instrument 180 experiences from percussion drilling operations.

Percussion drilling is an umbrella term that includes but is not limited to, reverse circulation drilling and rotary air blast drilling. The present invention may be suitable for any form of drilling where the drill string experiences high impact and/or repetitive impact forces. The forces that the measuring instrument 180 experiences may be axial, radial and/or rotational shock/vibration experienced independently, or a combination of the aforementioned. Such forces may impede the measuring instrument 180 from collecting accurate data and/or functioning entirely.

In an embodiment, the compressible/resilient ring 160 is a polyurethane ring 160. The silicone damper 130 and polyurethane ring 160 are housed within the shroud 124. The silicone damper 130 comprises a smaller diameter plate 154 which has a post 138 projecting therefrom for inserting into the support post hole 150 of the support 186 positioned on each respective end of a backplate 184 to which the measuring instrument 180 is rigidly coupled, such as by screws. The shroud 124 assists the silicone dampers 130 and the polyurethane rings 160 to stay inline with the backplate 184 or other measuring instrument, such as gamma ray detector 182, while also preventing the dampers from deforming outside the bounds of the inner boundary of the shrouds 124. The shrouds 124 reduce or prevent lateral motion of the silicone damper 130 and the polyurethane rings 160. The silicone damper 13 is prevented from moving outside the inner diameter of the shroud 124. The person skilled in the art will readily appreciate that many arrangements and types of dampers may be used in place of the described dampers based on the expected conditions the body 10 will experience during operation.

For example, where axial forces are the only shock/vibration expected to be experienced the polyurethane rings 160 may be removed. Furthermore, the polyurethane ring 160 may be replaced with a damper that dampens axial vibration such as a second silicone damper 130. Alternatively, where rotational forces are the only shock/vibration expected for the measuring instrument 180 to experience, multiple dampers which dampen rotational forces may be employed. This may be in the form of multiple polyurethane rings 160 which have differing damping properties that independently or in combination to account for the expected shock/vibration conditions.

Referring to FIGS. 4, 4A and 5, there is provided measuring instrument 180, such as a motion/orientation measuring instrument, in a front view and side view (FIGS. 4 and 5 respectively) and a gamma ray detector 182 (in FIG. 4A). Each of the measuring instruments 180 and gamma ray detector 182 are coupled between two damping apparatuses 110 for installation into a compartment 212 of the body 10. The measuring instrument may comprise a number of instruments including, but not limited to, a gyroscope and/or an accelerometer.

Referring to FIG. 11, the silicone damper 130 comprises a larger diameter plate 152 having surface 132. The smaller diameter plate 154 has surface 134. Preferably, surfaces 132 and 134 are parallel to each other. The silicone is between, and preferably adhered to, the surfaces 132 and 134. Surface 132 has a post 136 projecting therefrom and surface 138 has a post 138 projecting therefrom. The posts 136 and 138 are axially aligned. In an embodiment, the posts 136 and 138 are distinct and separate connected by their mutual attachment to the silicone therebetween. The surfaces 134 and 136 of plates 152 and 154 are able to bear against other surfaces as described further below in compression and the silicone elastically deforms. The elastic deformation in compression has a damping effect. The same may occur in tension. The posts 136, 138 may be urged to move out of alignment due to shock vibration during the percussion drilling. The silicone therebetween resiliently urges then to return to alignment, thereby having a dampening effect.

In an embodiment, plate 132 is of a larger diameter surface than the diameter of plate 134. The post 136 provides means to rigidly affix the silicone damper 130 to the shroud 124 by extending through a centre hole 140 of the shroud 124. The centre hole 140 may be threaded. The post 136 may be threaded to provide a means for the post 136 to be rigidly affixed to the shroud 124. The post 136 may be affixed by way of a nut, preferably a self tightening nut or vibration resistant nut such as a Nyloc™ nut 156. Alternatively, a locking or sealing adhesive, such as Loctite™ or a self locking washer, such as Nordlock™ may be used. The post 138 provides for insertion into the hole 150 in the support 186 to provide a connection which allows for flexibility and movement of the backplate 184 and measuring instrument 180 in response to shock/vibration from percussion drilling.

The backplate 184 and measuring instrument 180 may be interchangeable with any measuring tool or apparatus having supports 186 affixed at respective longitudinal ends with dimensions which fit within the compartments 212, such as gamma detector 182. To fit within the compartments the length of the measuring tool and damping apparatuses must line up with a respective hole in the sidewall 114 of the compartment 212.

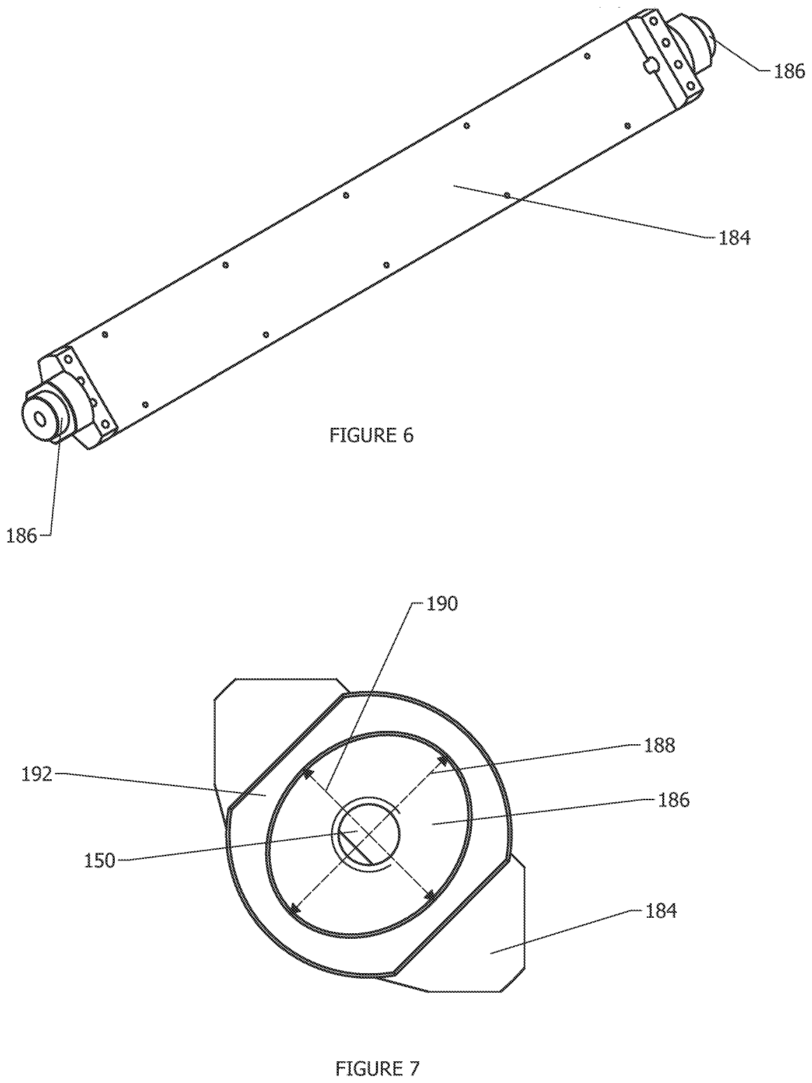

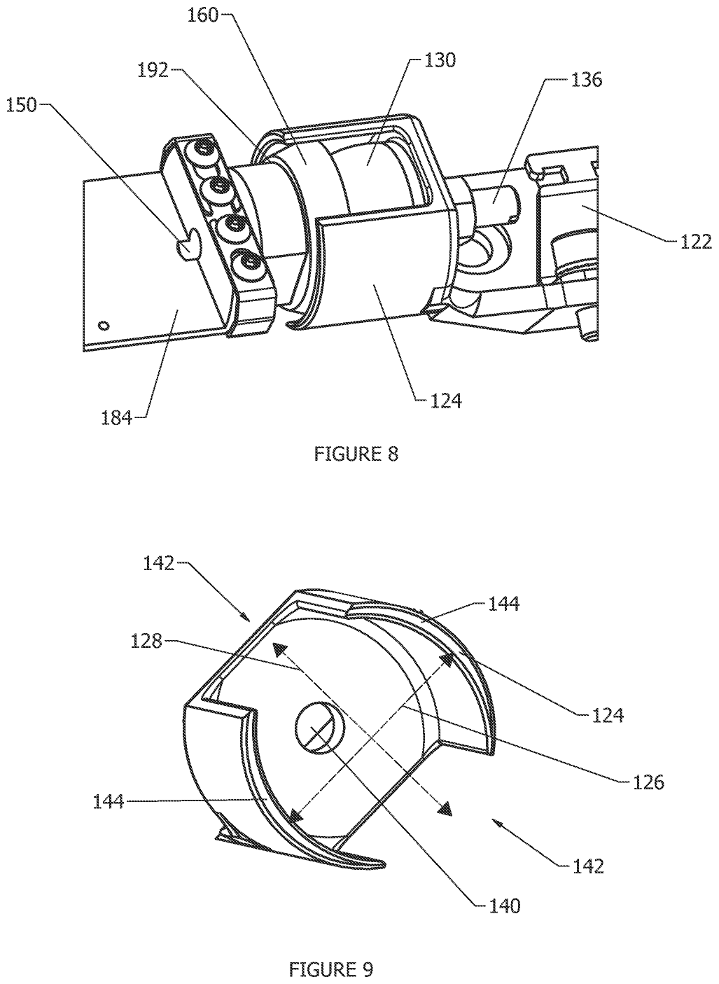

FIG. 6 shows the backplate 184 suitable for fixing the measuring instrument 180 or other componentry such as a PCB board. The backplate 184 has a length such that each longitudinal end comprises a support 186 (shown in FIG. 7). The damping apparatuses 110 are affixed to the body 10 such that the backplate 184 and measuring instrument 180 are fixed in a damped arrangement between the damping apparatuses 110. FIG. 8 provides an isometric view of the damping apparatus 110, specifically the housing of the silicone damper 130 and polyurethane ring 160 within the shroud 124. The interrelation between these features will be discussed below in more detail.

Referring to FIG. 9, the shrouds 124 are elliptical in shape having a major axis 126 and a minor axis 128. Each shroud 124 has curved side walls 144 separated by gaps 142. The major axis 126 define the maximum separation of the side walls 144. The minor axis 128 defines the separation of the gaps in the side walls 144. The side walls 144 define a void that receives the respective silicone damper 130 and the polyurethane ring 160 flexed around the support 186 (discussed in detail below). The support 186 is elliptical in shape and has a major axis 188 and a minor axis 190. The major axis 188 of the support 186 and the major axis 126 of the shroud 124 are parallel when in a neutral position. The major axis 188 of the support 186 is less than or equal in length to the minor axis 128 of the shroud 124.

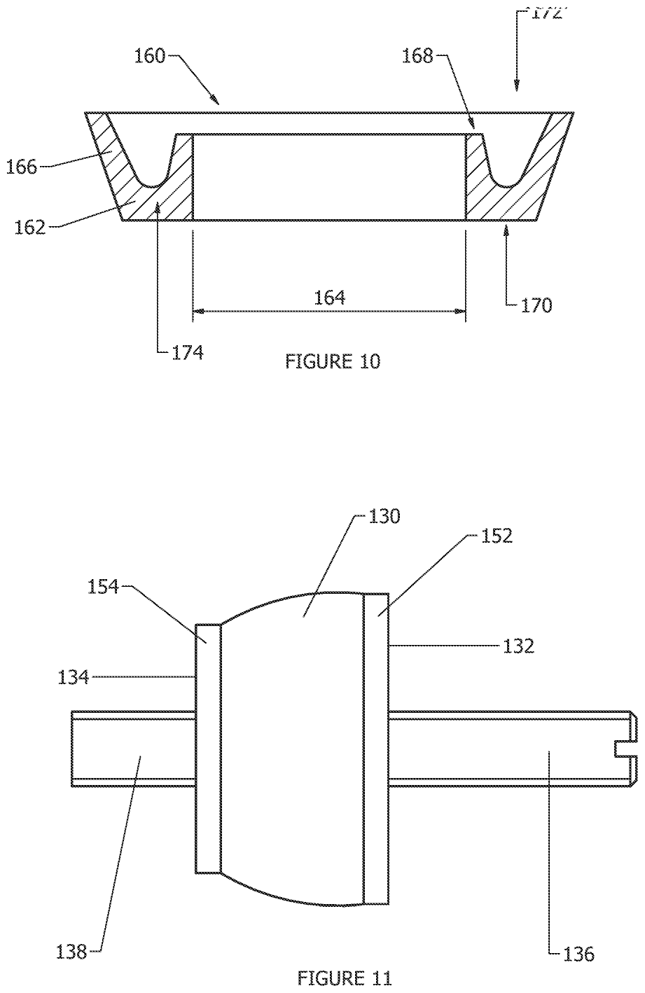

Referring to FIG. 10, there is provided a cross section of a polyurethane ring 160. The polyurethane rings 160 are flexible and are formed into a substantially ‘U’ or ‘V’ shaped cross section 162 allowing further flexibility and manipulability. The polyurethane rings 160 may comprise a suitable cross-sectional shape, such as an ‘S’ shape, provided they fit around the support and provide a suitable damping effect as described herein. A bridge 174 between the legs of the V/U forms a pivot with a gap 172 therebetween. The polyurethane ring 160 has an outer surface 166 formed of one leg of the V/U and a substantially circular centre 164 formed of the other leg. The outer surface 166 may be at an angle to the central axis of the polyurethane ring 160. The circular centre 164 may be co-axial with the central axis. The centre 164 is able to flex to receive the support 186. There is a ring 160 on each support 186 on each respective end of the backplate 184. The gap 172 between the legs can be closed by radial compression of the inside of the centre 164 and the outside of the ring 166. Once the gap 172 is closed further radial force will elastically compress the centre 164 towards the outer surface 166.

As the major axis 188 of the support 186 is less than or equal in length to the minor axis 128 of the shroud 124, the polyurethane ring 160 prevents the major axis 188 of the support 186 from moving to be parallel with the minor axis 128 of the shroud 124 due to it interposing between the support 186 and the side walls 144 and by that imposition causing the polyurethane ring 160 to be elastically radially compressed by a force urging the support 186 to rotate about the post 136, or otherwise move in stages as the gap 174 is closed and then further compressed once the gap 174 is closed.

The supports 186 on each end of the backplate 184 comprise a shoulder 192. The polyurethane ring 160 is coupled to the support 186 by the support 186 being inserted into the centre hole 164 and the surface 170 of each polyurethane ring 160 abutting against shoulder 192.

Referring to FIG. 11, there is provided a side view of the silicone damper 130. the silicone damper 130 is shaped having a larger diameter side 132 which is received directly into and abuts the shroud 124. Each silicone damper 130 tapers inward to a smaller diameter side 134 which is concentrically aligned and abuts with a respective polyurethane ring 160 on an upper face 168 (see FIG. 10). This will be discussed further below.

Referring to FIG. 11A, there is provided a custom moulded damper 500 comprising a silicone core 514 fixed intermediate a first shell portion 510 and a second shell portion 512. The silicone core 514 may comprise the soft silicone gel, such as Alpha GEL made by Taica Corporation, as mentioned above. Similar to silicone damper 130, other suitable materials for the silicone core 514 may include, but are not limited to, polymers, such as sorbothane, or one of a number of compositions of room temperature vulcanizing (RTV) silicone.

To increase the rotational damping response, posts (not shown) may extend radially from the first shell portion 510 and/or the second shell portion 512 into the silicone core 514. The addition of the radially extending posts provides additional surface area to receive a response from the silicone core 514 during movement. The custom moulded damper 500 may act as an alternative or a replacement to the silicone damper 130 and affixed similar between the backplate 186 and the shroud 124 in a similar or otherwise suitable manner. Alternative embodiments may use a combination of different dampers described herein.

Referring to FIG. 11B, there is provided an alternative damping arrangement comprising O-rings 610, 612 around the support 186 between the backplate 184 and a housing 614. The housing 614 may be rigidly fixed to the mount 122 with a suitable fastener or integrally formed with the mount 122 (as seen in FIGS. 4, 4A and 5). In this embodiment the damper comprises two O-rings positioned radially between the support 186 and the housing 614 and a single O-ring positioned axially between the support 186 and the housing 614.

The number of each type of O-rings provided are for exemplary purposes. There may be 1, 2, 3, 4, 5, 6 or more O-rings positioned radially between the support 186 and the housing 614. Similarly, there may be 1, 2, 3, 4, 5, 6 or more O-rings positioned axially between the support 186 and the housing 614. The support 186 and housing 614 each may comprise one or more shoulders for seating each of the O-rings axially between the support 186 and the housing 614. The O-rings may comprise the same or varying compositions of materials such that the overall damping effect can customised for a specific application. The support 186 may also be elliptical in shape (as shown in FIG. 7) and comprise a polyurethane ring 160 as described herein to provide additional damping response to rotation.

Referring to FIG. 12A again, the damping apparatus is shown having the mount 122 rigidly affixed to the body 10. The mount 122 provides means for rigidly affixing the shroud 124 to the mount 122. A pin 136 on the larger diameter side 132 of each silicone damper 130 is inserted through the shroud 124 to rigidly fix the silicone damper 130 to a respective shroud 124. Each silicone dampers 130 smaller diameter side 134 comprises a pin 138 for insertion into a respective support 186, the support having a polyurethane ring 180 flexed around its major axis 188. In this manner, each silicone damper 130 is positioned between the shroud 124 and the backplate 184 in the axial direction and each polyurethane ring 180 is positioned between the support 186 and the shroud 124 in the radial direction. Modifications to the placement of the dampers, such as silicone damper 130 and polyurethane ring 160, relative to the shroud 124 may vary for based on considerations which included, but are not limited to, the type of damper being used and the spatial constraints.

The spatial positioning of the measuring instruments 180 within the compartments 212 can be seen in FIG. 12B. In this embodiment, the measuring instruments 180 are affixed between two damping apparatuses. The damping apparatuses are spaced apart longitudinally to provide support along the length of the backplate 184. Alternative embodiments may require more or less damping apparatuses which will be discussed in detail below. During a percussion drilling operation, the black plate 184 of measuring instrument 180 can move such as for example illustrated by the double headed arrows. Sufficient clearance is provided between the extreme dimensions of the black plate 184 of measuring instrument 180 and the inside surface of the compartment 212 and the inside wall of the casing 12 such that contact does not occur.

During operation of the percussion drill the rotational forces may cause the backplate 184 to rotate with respect to the body 10 which will cause the respective major axes 188 of the supports 186 to rotate towards the respective minor axes 128 of the shrouds 124. As the rotation of the plate occurs the polyurethane rings 160 will compress due to the material properties and cross-section 162. The compression resists against this rotation providing dampening until it reaches a maximum point. The maximum point being no further than where the major axis 188 of the support 186 and the minor axis 128 of the shroud 124 align. The ring is selected so that the resistance due to compression is elastic and the maximum expected forces applied do not reach plastic deformation and the rotation does not reach the maximum point.

In an embodiment, the polymer ring dampens by elastically resisting deformation urging legs of the U or V shape together until they meet and then dampens by elastically resisting deformation of the legs being compressed further together. In particular, the cross-section 162 and material properties allow the polyurethane ring 160 to elastically deform as the major axis 188 of the support 186 rotates towards the minor axis 128 of the shroud 124. The elastic deformation of the polyurethane ring 160 provides increasing resistance against the support 186 to the continued rotation of the support 160. Likewise, the elastic deformation of the silicone damper 130 provides increasing resistance to other directional forces. In this manner, the vibration/shock from the rotation of the measuring instrument 180 being coupled to the backplate 184 is reduced to a level which the measuring instrument 180 is capable of functioning.

For example, the average acceleration the drill rod positioned immediately above the bottom hole assembly experiences at any given time during operation is approximately a peak of 2500 g-force. The damping apparatus described herein allows the body 10 to perform the same function of a standard drill rod while also reducing the acceleration experienced by the measuring instrument closer to approximately a peak of 20 g-force. Where previously measure while drilling operations were not possible due to the shock/vibration experienced during percussion drilling operations, the damping apparatus reduces/eliminates enough shock/vibration such that measure while drilling operations can be conducted. Without the damping apparatus described herein a measuring instrument would be destroyed making measure while drilling operations impractical or impossible to be employed during percussion drilling operations.

Alternative embodiments of the present invention may require more or less damping apparatuses to be used to dampen the shock/vibration. The backplate 184 in the embodiment provided is of such a length, shape and/or mass that having a damping apparatus at each end provides an optimal reduction of vibration/shock. However, where the measuring instrument 30 only requires a plate 38 that is shorter it may be sufficient to couple it to a single damping apparatus. Alternatively, if the measuring instrument 30 is longer requiring the plate to be longer, there may be a further damping apparatus providing at some point along the length of the plate 38. The damping apparatus provided along the length of the plate 38 may comprise a radial damper. Additional dampers may be employed depending on the expected conditions to be experienced.

Alternative damping apparatuses may incorporate a number of alternative dampers or components including, but not limited to, springs or fluid dampers. Springs may be used to resist and/or dampen the rotation of the backplate 184 with respect to the body 10. Alternatively, or in addition, fluid dampers may be used which work by moving a planar body through a viscous fluid. The viscous fluid resists and/or dampens the movement of the planar body which resists and/or dampens the movement of the backplate 184 and support 186.

Alternative rotational dampers include having one or more bodies radially extending within a rubber or elastomer body, such as silicone damper 130. The radially extending bodies can rotate against a cushion like body, such as the silicone, provided by the rubber or elastomer body but are biased towards their initial position within the rubber body. For example, as discussed briefly above, the post 138 of the plate 154 may extend through a portion or all of the silicone damper 130 without connecting to the other post 136 of the plate 152 of the silicone damper. The post 138 may have one or more radially extending bodies within the boundaries of the silicone of the silicone damper 130. In this embodiment the post 138 would be rigidly connected to the plate 184. As the plate 184 rotates the post 138 also rotates thereby moving the bodies radially extending through the silicone damper 130. The radially extending bodies dampen the rotational force while also providing a resistance and biasing force to return the post 138 and therefore, the backplate 184 to its neutral orientation.

The shape of the shroud 124 and support 186 may have a circular or other shaped cross section where alternative damping means for damping and/or resisting rotation of the backplate 184 or other measuring tool, such as a gamma ray detector 182, relative to the body 10.

FIG. 12B shows the body 10 in more detail it has a plurality and in this case four supply channels 318 which receives air from a single annulus of a standard double walled drill rod to the upper end 14 of the body 10. The backplate 184 has the measuring instrument 180 within the compartments 212 isolated from the fluid supply channels 318 and a fluid return channel 320. The fluid return channel 320 receives fluid from the bottom hole assembly at the lower end 18 of the body 10 and provides it to a central tube of the standard double walled drill rod.

In use measuring the orientation of a measurement tool during percussion drilling operations comprises drilling a hole using a drill string having a percussion drill bit and a measuring instrument; and measuring the orientation of the tool as the hole is being drilled. As the drill string progressed into the drilled bore hole the action of the percussion drill bit is paused to add another drill rod, and when the drill string is extracted drill rods are removed. During each pause in drilling the measuring instrument takes a calibration measurement. The damper apparatus permits the measuring instrument to survive the shock/vibration it experienced during the drilling.

In an embodiment, the shock/vibration that is damped is at least 2000G force, possibly 3000G force or more and typically in the order of 3500G force. In an embodiment, the shock/vibration experience by the measuring instrument is damped to less than 500G force, preferably less than 300G force, more preferably less than 200G force, even more preferably less than 100G force, and more preferably still in the order of 30G force. In an embodiment, the shock/vibration that is damped by at least an order of magnitude.

Measurements were conducted to test the effectiveness of the present invention. The accelerations in all three axes were measured with and without the damper apparatus described. The drill bit was actuated at a drill site to measure the un-damped forces, with a supply pressure to a RC drill of 450 psi a rate of penetration of 1 m/min, rotation speed of 50-55 RPM and an air flow rate of 600 l/s. The measured 1.7 m from the bit was half sine pulse equivalent force was 3700 g in the x Axis, 1200 g in the y axis and 5200 in the z axis.

Then a test drill against a rubber block was established in a test environment. One shock mounted sensor system with an aluminum test chassis that weighed 410 grams and one with a steel chassis weighing 512 grams were tested. Each test setup was subjected to approx. 1 minute of drilling into the rubber block and the vibration data of the test chassis was recorded.

The steel 512 g chassis experience RMS acceleration as follows:
x-axis—1.26 g y-axis—1.42 g z-axis—1.46 g

The steel 512 g chassis experience peak acceleration as follows:
x-axis—8.49 g y-axis—18.27 g z-axis—21.25 g

The aluminium 410 g chassis experience RMS acceleration as follows:
x-axis—1.64 g y-axis—2.08 g z-axis—1.47 g

The aluminium 410 g chassis experience peak acceleration as follows:
x-axis—7.72 g y-axis—10.52 g z-axis—21.25 g

In an embodiment, the calibration measurement comprises taking a first measurement at a first position then rotating 180 degrees and taking a second measurement at a second position.

In the context described herein, pneumatic percussion drilling is where there is a hammer actuated by pressurised air that strikes an anvil component of or connected to a drill bit so that the drill bit impacts on rock on the bottom of a drill hole so as to break the rock. The hammer is directly next to the drill bit. This type of percussion drilling is used in rotary air blasting (RAB) and reverse circulation drilling (RC drilling). Pneumatic percussion drilling is used in mineral exploration. It is to be distinguished from hydraulic (often water or mud) powered percussion drilling used in hydrocarbon well drilling. It is also to be distinguished from mechanical percussion drilling where the drill string is lifted and dropped, usually from the surface. In hydraulic and mechanical percussion drilling a casing within which the drill string can move is usually used. However, in pneumatic percussion drilling a casing is usually not used.

RC drilling will be understood to be where the pressurised air flow is also used to blow the rock broken by the drill bit impact into one or more holes in the drill bit and then up through the drill string. The drill rods have an inner tube through which the air and recovered rock return to the surface and an outer tube, which between this and the inner tube, the pressurised air travels down the drill string to the hammer and the drill bit. This is distinguished from RAB, which is where the broken rock air is blown up the drill hole outside of the drill string. The inner tube is not required in the drill rods for RAB.

Percussion drilling can be distinguished from air core drilling where the drill bit cuts, rather than breaks from impact, but there is pressurised air that returns the cuttings through the drill string. Percussion drilling can also be distinguished from diamond core drilling where ring is cut by diamond teeth and a core sample can be retrieved.

The sensors in the measuring instrument maybe for example accelerometers, such as micro-mechanical systems (MEMS) accelerometers, and gyroscopes, such as MEMS gyroscopes or fibre optic gyroscopes. Suitable devices include TDK Tronics Gyror3300, Gladiator DIGS100, Fitzoptika VG091A-4LD, Analog Devices ADIS16465-2 or Silicon Sensing CRH03. Typically the sensors are arranged to provide 3 axes of acceleration measurement and 3 polar axes of rotational measurement so as to provide an Inertial Measuring System which can measure while moving and can auto-correct for drift while stationary, such as during rod addition/removal.

Modifications may be made to the present invention within the context of that described and shown in the drawings. Such modifications are intended to form part of the invention described in this specification.

1.-27. (canceled)

28. A damper apparatus for use in reverse circulation pneumatic percussion drilling comprising:
a body having one or more damper portions supporting a measuring instrument;
wherein the or each damper portion dampens shock/vibration from the pneumatic percussion drilling that would be experienced by the measuring instrument.

29. A damper apparatus according to claim 28, wherein the shock/vibration may comprise independently, or in combination, axial, radial and/or rotational shock/vibration.

30. A damper apparatus according to claim 28, wherein the one or more damper portions comprise at least two resiliently compressible portions having different elasticity.

31. A damper apparatus according to claim 28, the body comprising at least three damper portions, each having a different elasticity.

32. A damper according to any one of claim 28, wherein the or each damper portion comprises a silicone compressible body.

33. A damper according to claim 31, wherein a first damper portion is configured to elastically resist deformation by a first material being in compression.

34. A damper according to claim 31, wherein a second damper portion is configured to elastically resist deformation by bending or flexing of a first thickness of a second material.

35. A damper according to claim 34, wherein the second damper portion is configured to elastically resist deformation by a second thickness of the second material being in compression.

36. A damper apparatus according to claim 30, wherein each resiliently compressible portion comprises a silicone compressible body.

37. A damper apparatus for use in pneumatic percussion drilling comprising:
a body having at least two resiliently compressible portions supporting a measuring instrument; at least two of the resiliently compressible portions having different elasticity; wherein one or more of the at least two resiliently compressible portions comprise polymer ring dampers, wherein each polymer ring is substantially ‘U’ or ‘V’ shaped in cross section, and wherein the resiliently compressible portions dampen shock/vibration from the pneumatic percussion drilling that would be experienced by the measuring instrument.

38. A damper apparatus according to claim 37, wherein the polymer ring dampers are comprised of polyurethane.

39. A damper apparatus according to claim 37, wherein, the polymer ring dampers dampen by elastically resisting deformation urging legs of the U or V shape together until they meet and then dampen by elastically resisting deformation of the legs being compressed further together.

40. A damper apparatus for use in pneumatic percussion drilling comprising:
a body having one or more damper portions supporting a measuring instrument;
wherein the one or more damper portions comprise one or more elliptical resiliently compressible portions housed in a movement limiting portion; wherein the movement limiting portion comprises a shroud having an elliptical formed wall; wherein the elliptical formed wall receives the elliptical resiliently compressible portion and interaction of the elliptical wall and elliptical resiliently compressible portion limits rotation of the resiliently compressible portion, and wherein the or each damper portions dampens shock/vibration from the pneumatic percussion drilling that would be experienced by the measuring instrument.

41. A damper apparatus according to claim 40, wherein a support between the body and the resiliently compressible portions and/or movement limiting portions is elliptical in form.

42. A damper apparatus according to claim 41, wherein the or each resiliently compressible portion is between the support and the shroud in a radial direction.

43. A damper apparatus according to claim 40, wherein a major axis of the support is longer than a minor axis of the shroud.

44. A damper apparatus according to claim 43, wherein the major axis of the support is prevented from rotating across the minor axis of the shroud.

45. A damper apparatus according to claim 43, wherein a shock/vibration damping force from the movement limiting portion increases as the major axis of the support rotates towards the minor axis of the shroud.

46. A damper apparatus for use in pneumatic percussion drilling comprising:
a body having one or more damper portions supporting a measuring instrument;
wherein the or each damper portions comprise one or more resiliently compressible portions housed in an elliptical shroud; wherein a support between the body and the resiliently compressible portions and/or shroud is elliptical in form; wherein a major axis of the support is longer than a minor axis of the shroud, wherein the major axis of the support is prevented from rotating across the minor axis of the shroud, and wherein the or each damper portion dampens shock/vibration from the pneumatic percussion drilling that would be experienced by the measuring instrument.

47. A drilling apparatus comprising the damper apparatus according to claim 28.

48. A method of measuring while pneumatic percussion drilling, comprising supporting a measuring instrument within a body of a drill string and damping shock/vibration from pneumatic percussion drilling with the drill string so as to dampen the shock/vibration as experienced by the measuring instrument.

49. A damper apparatus for use in percussion drilling comprising:
a body having one or more damper portions supporting a measuring instrument;
wherein the or each damper portion dampens shock/vibration from the percussion drilling that would be experienced by the measuring instrument, wherein the one or more damper portions comprises at least two portions each comprising a different elasticity.

50. A damper apparatus according to claim 28, wherein the shock/vibration that would be damped is at least 2000G force.
